(19) United States
(12) Patent Application Publication
(10) Pub. No.: US 2002/0167260 A1
(43) Pub. Date: Nov. 14, 2002

(54) Electron gun assembly for cathode ray tube

(76) Inventor: Tae-Sik Oh, Suwon-city (KR)

Correspondence Address: Robert E. Bushnell, Suite 300, 1522 K Street, N.W., Wahington, DC, 20005, US

(21) Appl. No.: 10/076,322

(22) Filed: Feb. 19, 2002

(30) Foreign Application Priority Data
May 8, 2001 (KR) 2001-24977

(51) Int. Cl. H01J 29/50

(52) U.S. Cl. 313/414

(57) ABSTRACT

Disclosed is an electron gun assembly for a cathode ray tube comprising a single cathode for emitting electrons; a first electrode and a second electrode mounted in this order from the cathode in the direction the electrons are emitted, the cathode and the first and second electrodes forming a triode portion; a plurality of focusing electrodes mounted one after the other away from the second electrode in the direction the electrons are emitted; an anode electrode mounted away from the furthermost focusing electrode in the direction the thermions are emitted; and a support for providing support to the above elements in the mounting sequence as described, wherein the first and second electrodes include a plurality of beam passage apertures, which are aligned on each the first and second electrodes in a direction perpendicular to a direction at which an electron beam is scanned.

### CLAIM OF PRIORITY

This application makes reference to, incorporates the same herein, and claims all benefits accruing under 35 U.S.C. §119 from my application ELECTRON GUN ASSEMBLY FOR CATHODE RAY TUBE filed with the Korea Industrial Property Office May 8, 2001 and there duly assigned Serial No. 24977/2001.

### BACKGROUND OF THE INVENTION

1. Technical Field

The present invention relates to an electron gun assembly for a cathode ray tube, and more particularly, to an electron gun assembly for a cathode ray tube, in which the electron gun assembly includes a cathode that emits a single electron beam toward a phosphor screen, during which fine adjustments of a spot size of the electron beam are able to be performed.

2. Related Art

One type of cathode ray tube (CRT) is the beam index cathode ray tube. In the beam index cathode ray tube, a single electron beam is emitted from an electron gun, and by using index signals that are detected from the illumination of a plurality of index stripes provided on a phosphor screen, color separation of the electron beam is performed to a desired phosphor layer.

I have found that methods to control the spot size of the electron beam to a small size have been attempted. For example, consider Japanese Patent Publication Number 06-203766, listing inventor Keiji Yanai, published on Jul. 22, 1994, filed on Dec. 28, 1992, entitled Electron Gun for Index Color Picture Tube, and having Application Number 04-348433 (Yanai '766). Yanai '766 discloses a configuration in which beam passage apertures formed in a first electrode and a second electrode are elliptical with a vertical major axis such that the spot of the electron beam is also elliptical when striking the phosphor screen.

Also consider Japanese Patent Publication Number 08-212947, listing inventors Yukinobu Iguchi and Ichiro Uchiumi, published on Aug. 20, 1996, filed on Nov. 6, 1995, entitled Beam Index Type Cathode Ray Tube, and having Application Number 07-287527 (Iguchi '947). Iguchi '947 discloses a configuration wherein a pair of electromagnetic quadruple poles and/or electrostatic quadruple poles is formed in a main focus lens region such that a horizontal diameter of the electron beam is reduced.

With use of the above structures and other structures for the electron gun assembly, if a cathode current is increased to realize bright pictures, the spot size of the electron beam landing on the phosphor screen is increased, causing a decrease in picture quality. While the above-described efforts provide advantages, I note that they fail to adequately provide an electron gun assembly for a cathode ray tube efficiently and conveniently allowing fine adjustment of a spot size of the electron beam.

### SUMMARY OF THE INVENTION

It is an object of the present invention to improve a display resolution. It is a further object of the present invention to provide an electron gun assembly for a cathode ray tube, in which fine adjustments of a spot size of an electron beam emitted toward a phosphor screen may be performed such that only desired colors are illuminated, thereby improving a display resolution.

To achieve the above objects and others, the present invention provides an electron gun assembly for a cathode ray tube comprising a single cathode for emitting electrons; a first electrode and a second electrode mounted in this order from the cathode in a direction the electrons are emitted, the cathode and the first and second electrodes forming a triode portion; a plurality of focusing electrodes mounted one after the other away from the second electrode in the direction the in electrons are emitted; an anode electrode mounted away from the furthermost focusing electrode in the direction the electrons are emitted; and a support for providing support to the above elements in the mounting sequence as described, wherein the first and second electrodes include a plurality of beam passage apertures, which are aligned on each of the first and second electrodes in a direction perpendicular to a direction at which an electron beam is scanned.

According to a feature of the present invention, the beam passage apertures of the first and second electrodes are identical in size and shape, and each of the beam passage apertures of the first electrode corresponds to a beam passage aperture of the second electrode by a center axis thereof being aligned with a center axis of the corresponding beam passage aperture of the second electrode in a tube-axis direction of the cathode ray tube.

According to another feature of the present invention, the beam passage apertures of the first and second electrodes satisfy the following conditions:

0.1 mm≦D≦0.3 mm, 2D≦L≦8D,

where D is a diameter of the beam passage apertures, L is a length extending from extreme points of outermost beam passage apertures in the vertical-axis direction of the cathode ray tube, and mm is millimeters.

According to yet another feature of the present invention, an imaginary axis passing through a center of at least one of the beam passage apertures of the second electrode in a tube-axis direction is distanced, in a direction perpendicular to a direction at which an electron beam is emitted, from an imaginary axis passing through a center of a corresponding beam passage aperture of the first electrode in the tube-axis direction of the cathode ray tube.

According to still yet another feature of the present invention, the at least one of the beam passage apertures of the second electrode is larger in diameter than its corresponding beam passage aperture of the first electrode.

According to still yet another feature of the present invention, the second electrode includes a first sub-electrode mounted opposing the first electrode, and a second sub-electrode mounted opposing the focusing electrode closest to the cathode, wherein the first and second sub-electrodes include a plurality of beam passage apertures, which are aligned on each of the first and second sub-electrodes in a vertical axis direction of the cathode ray tube.

According to still yet another feature of the present invention, the beam passage apertures of the first electrode and the first and second sub-electrodes are identical in size and shape, and each of the beam passage apertures of the first electrode corresponds to a beam passage aperture of the first and second sub-electrodes by a center axis thereof being aligned to a center axis of the corresponding beam passage aperture of the first and second sub-electrodes in a tube-axis direction of the cathode ray tube.

According to still yet another feature of the present invention, the beam passage apertures of the first electrode, the first sub-electrode, and the second sub-electrode satisfy the following conditions:

0.1 mm≦D≦0.3 mm, 2D≦L≦8D,

where D is a diameter of the beam passage apertures, and L is a length extending from extreme points of outermost beam passage apertures in the vertical-axis direction of the cathode ray tube.

According to still yet another feature of the present invention, an imaginary axis passing through a center of at least one of the beam passage apertures of the second sub-electrode in a tube-axis direction is distanced, in a direction perpendicular to a direction at which an electron beam is scanned, from an imaginary axis passing through a center of a corresponding beam passage aperture of the first sub-electrode, in the tube-axis direction of the cathode ray tube.

According to still yet another feature of the present invention, the at least one of the beam passage apertures of the second sub-electrode is larger in diameter than its corresponding beam passage aperture of the first sub-electrode.

To achieve these and other objects in accordance with the principles of the present invention, as embodied and broadly described, the present invention provides an electron gun apparatus for a cathode ray tube, comprising: a single cathode emitting an electron beam, the electron beam being scanned in a scanning direction; a first electrode being mounted adjacent to said cathode, said first electrode forming a first plurality of beam passage apertures aligned in an alignment direction substantially perpendicular to the scanning direction; a second electrode being mounted adjacent to said first electrode, said first electrode being disposed between said second electrode and said cathode, said cathode and first and second electrodes forming a triode portion, said second electrode forming a second plurality of beam passage apertures aligned in the alignment direction, the electron beam penetrating at least one of the first plurality of beam passage apertures and at least one of the second plurality of beam passage apertures; a plurality of focusing electrodes being mounted adjacent to each other, said focusing electrodes including one focusing electrode mounted adjacent to said second electrode and including a last focusing electrode, the one focusing electrode being disposed between said second electrode and the last focusing electrode; an anode electrode being mounted adjacent to the last focusing electrode; and at least one support providing support to said cathode and said electrodes.

To achieve these and other objects in accordance with the principles of the present invention, as embodied and broadly described, the present invention provides an apparatus for a cathode ray tube, comprising: a cathode emitting an electron beam toward a screen, the electron beam being scanned in a scanning direction; a first electrode being mounted adjacent to said cathode, said first electrode forming at least three beam passage apertures aligned in an alignment direction perpendicular to the scanning direction; a second electrode being mounted adjacent to said first electrode, said first electrode being disposed between said second electrode and said cathode, said second electrode forming at least three beam passage apertures aligned in the alignment direction, each one of the beam passage apertures of said first electrode being formed to have a position corresponding to a respective one of the beam passage apertures of said second electrode; three focusing electrodes being mounted adjacent to each other, said focusing electrodes including a first focusing electrode mounted adjacent to said second electrode and including a last focusing electrode, the first focusing electrode being disposed between said second electrode and the last focusing electrode; an anode electrode being mounted adjacent to the last focusing electrode, the electron beam being emitted through at least one of the beam passage apertures of said first electrode, at least one of the beam passage apertures of said second electrode, said focusing electrodes, and said anode electrode and to the screen; and at least one support providing support to said cathode and said electrodes.

To achieve these and other objects in accordance with the principles of the present invention, as embodied and broadly described, the present invention provides an apparatus for a cathode ray tube, comprising: a single cathode emitting an electron beam, the electron beam being scanned in a scanning direction; a first electrode being mounted adjacent to said cathode, said first electrode forming a plurality of beam passage apertures aligned in an alignment direction substantially perpendicular to the scanning direction; a second electrode being mounted adjacent to said first electrode, said first electrode being disposed between said second electrode and said cathode, said cathode and first and second electrodes forming a triode portions said second electrode forming a second plurality of beam passage apertures aligned in the alignment direction, each one of the first plurality of beam passage apertures being formed to have a position corresponding to a respective one of the second plurality of beam passage apertures; a plurality of focusing electrodes being mounted adjacent to each other, said focusing electrodes including a first focusing electrode mounted adjacent to said second electrode and including a last focusing electrode, the first focusing electrode being disposed between said second electrode and the last focusing electrode; an anode electrode being mounted adjacent to the last focusing electrode, the electron beam penetrating at least one of the first plurality of beam passage apertures, at least one of the second plurality of beam passage apertures, said focusing electrodes, and said anode electrode; and a support supporting said cathode and said electrodes; said cathode emitting the electron beam in a tube-axis direction substantially perpendicular to the scanning direction, the alignment direction being substantially perpendicular to the scanning and tube-axis directions; at least one of the first plurality of beam passage apertures having a center aligned with a center of a corresponding one of the second plurality of beam passage apertures as viewed in a direction substantially parallel to the tube-axis direction; at least one of the first plurality of beam passage apertures having a center not aligned with a center of a corresponding one of the second plurality of beam passage apertures as viewed in a direction substantially parallel to the tube-axis direction.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1 is a sectional view of a beam index cathode ray tube and a corresponding beams index circuit;

FIG. 2 is a partial enlarged view of a phosphor screen and an electron beam landing thereon;

FIG. 3 is a partial sectional view of an electron gun;

FIG. 4 is a partial enlarged view of a phosphor screen used to describe a spot formation of an electron beam emitted from an electron gun;

FIG. 5 is a sectional view of an electron gun assembly for a cathode ray tube, in accordance with a first preferred embodiment of the present invention;

FIG. 6 is a partial sectional view of the electron gun assembly of FIG. 5, in accordance with the principles of the present invention;

FIG. 7 is a partially enlarged sectional view of the electron gun assembly of FIG. 5, which is used to describe a path of an electron beam, in accordance with the principles of the present invention;

FIG. 8 is a partial enlarged view of a phosphor screen used to describe a spot formation of an electron beam emitted from the electron gun assembly of FIG. 5, in accordance with the principles of the present invention;

FIG. 9 is a schematic view of a first electrode and a second electrode of the electron gun assembly of FIG. 5, in accordance with the principles of the present invention;

FIG. 10 is a schematic view showing a first alternate configuration for the first and second electrodes of FIG. 9, in accordance with the principles of the present invention;

FIG. 11 is a schematic view showing a second alternate configuration for the first and second electrodes of FIG. 9, in accordance with the principles of the present invention;

FIG. 12 is a schematic view showing a third alternate configuration for the first and second electrodes of FIG. 9, in accordance with the principles of the present invention;

FIG. 13 is a sectional view of the first and second electrodes of FIG. 12, in accordance with the principles of the present invention;

FIG. 14 is a sectional view of the first and second electrodes of FIG. 12 used to describe a path of an electron beam, in accordance with the principles of the present invention;

FIG. 15A is a schematic view showing a fourth alternate configuration for the first and second electrodes of FIG. 10, in accordance with the principles of the present invention;

FIG. 15B is a schematic view showing a fifth alternate configuration for the first and second electrodes of FIG. 10, in accordance with the principles of the present invention;

FIG. 16A is a schematic view showing a sixth alternate configuration for the first and second electrodes of FIG. 11, in accordance with the principles of the present invention;

FIG. 16B is a schematic view showing a seventh alternate configuration for the first and second electrodes of FIG. 11, in accordance with the principles of the present invention;

FIG. 17 is a sectional view of an electron gun assembly for a cathode ray tube, in accordance with a second preferred embodiment of the present invention;

FIG. 18 is a partial sectional view of the electron gun assembly of FIG. 17, in accordance with the principles of the present invention; and

FIG. 19 is a sectional view of the first electrode, the first sub-electrode, and the second sub-electrode of FIG. 17 used to describe an alternate configuration for the second sub-electrode, in accordance with the principles of the present invention.

### DETAILED DESCRIPTION OF THE PREFERRED EMBODIMENTS

While the present invention will be described more fully hereinafter with reference to the accompanying drawings, in which preferred embodiments of the present invention are shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Illustrative embodiments of the invention are described below. In the interest of clarity, not all features of an actual implementation are described. In the following description, well-known functions or constructions are not described in detail since they would obscure the invention in unnecessary detail. It will be appreciated that in the development of any actual embodiment numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill having the benefit of this disclosure. Additionally, the embodiments disclosed can be combined.

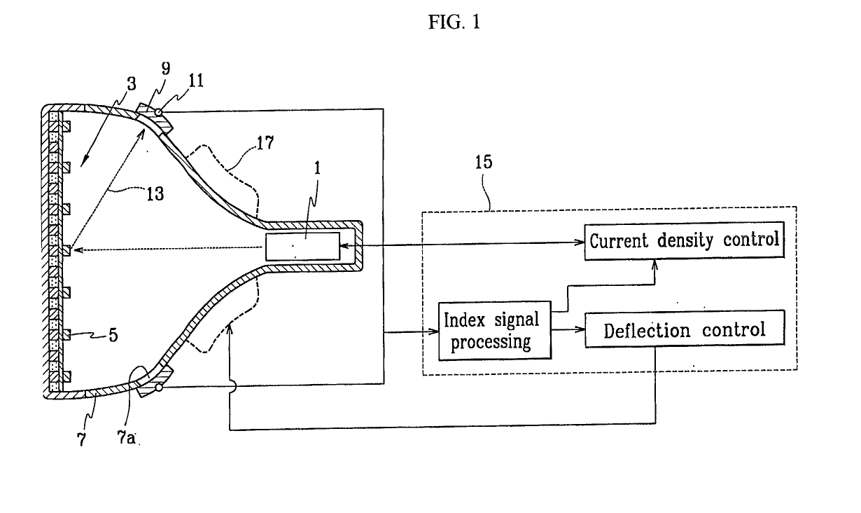

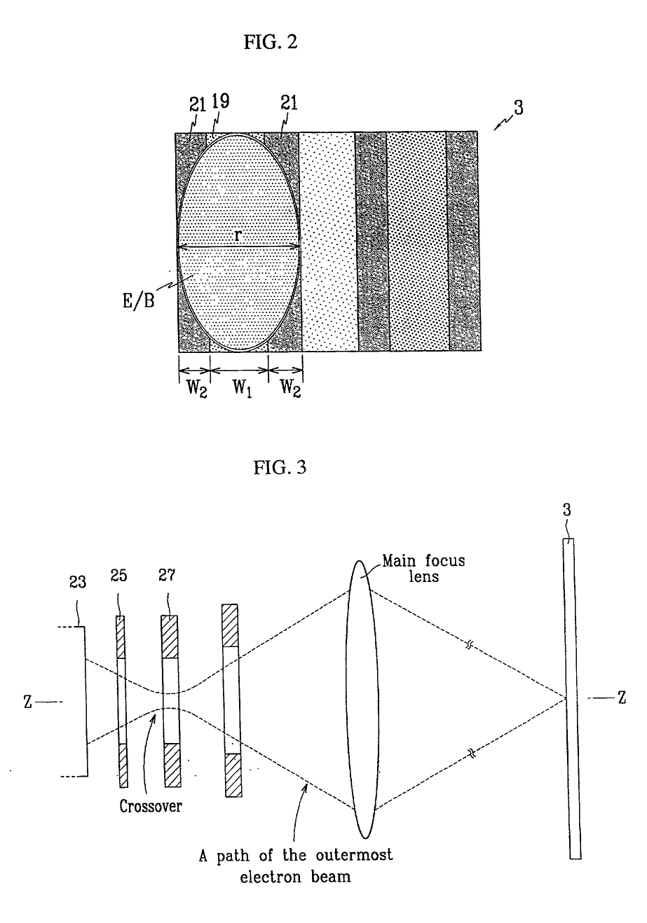

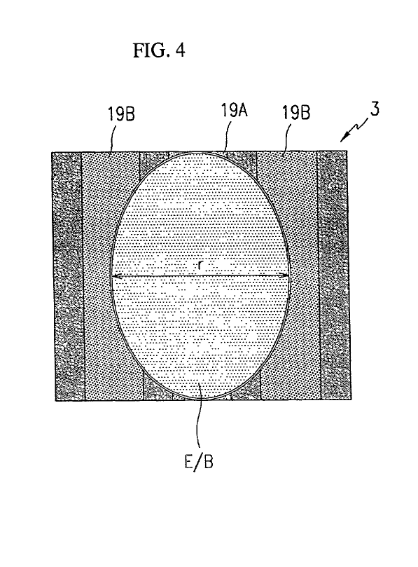

FIG. 1 is a sectional view of a beam index cathode ray tube and a corresponding beams index circuit. FIG. 2 is a partial enlarged view of a phosphor screen and an electron beam landing thereon. FIG. 3 is a partial sectional view of an electron gun. FIG. 4 is a partial enlarged view of a phosphor screen used to describe a spot formation of an electron beam emitted from an electron gun.

The beam index cathode ray tube includes a single electron gun 1 that emits a single electron beam. A plurality of index stripes 5 are formed on a phosphor screen 3, and a light sensor 11 is mounted to an exterior of a funnel 7 corresponding to the formation of a light-receiving window 7a. A condensing plate 9 may be positioned between the light-receiving window 7a and the light sensor 11.

With the above structure, if the electron beam emitted from the electron gun 1 excites the index stripes 5 such that index light 13 of an ultraviolet ray region is emitted, the condensing plate 9 and the light sensor 11 detect the index light 13 and convert the index light 13 to an electrical index signal. An index circuit 15 receives the index signal and synchronizes the index signal with a color signal, then outputs a control signal to control a current density and a degree of deflection of the electron beam. The control signal is received by the electron gun 1 and a deflection yoke 17 such that the electron beam lands on a desired phosphor layer.

Compared to other cathode ray tube configurations, the beam index cathode ray tube does not have mis-convergence problems since there is emission of only a single electron beam. The problems of doming and moire do not occur since a shadow mask is not required. However, it is extremely important to maintain a small spot size of the electron beam in the beam index cathode ray tube. That is, with reference to FIG. 2, to prevent illumination of undesired colors, it is necessary that a horizontal diameter (r) of an electron beam (E/B) be smaller than the sum of a width w1 of a single phosphor layer 19 and widths w2 of black matrix regions 21 on both sides of the same phosphor layer 19. In other words, with reference to FIG. 2, it is necessary for the following expression to be true: r<(w1+w2+w2).

With use of the above-described structures of Yanai '766 and Iguchi '947 for the electron gun assembly, if a cathode current is increased to realize bright pictures, the spot size of the electron beam landing on the phosphor screen is increased, causing a decrease in picture quality. The spot size is increased for various reasons, as explained below.

With reference to FIG. 3, after an electron beam emitted from a cathode 23 undergoes crossover between a first electrode 25 and a second electrode 27, the electron beam undergoes divergence toward a main focus lens, which then converges the electron beam toward a phosphor screen 3. If the cathode current is increased, a size of the crossover is enlarged such that the effect of repelling a space charge is increased. This increases the spot size of the electron beam.

Furthermore, with an increase in cathode current, since a divergence angle of the electron beam directed toward the main focus lens is increased, outermost portions of the electron beam are significantly affected by spherical aberration. As a result, a focus point of the electron beam strays from its intended target such that the spot size of the electron beam is further increased where landing occurs on the phosphor screen 3.

Therefore, with reference to FIG. 4, the horizontal diameter (r) of the electron beam (E/B) landing on the phosphor screen 3 is enlarged so that in addition to illumination of an intended phosphor layer 19A, it also illuminates an adjacent phosphor layer 19B of a different color, thereby negatively affecting picture quality.

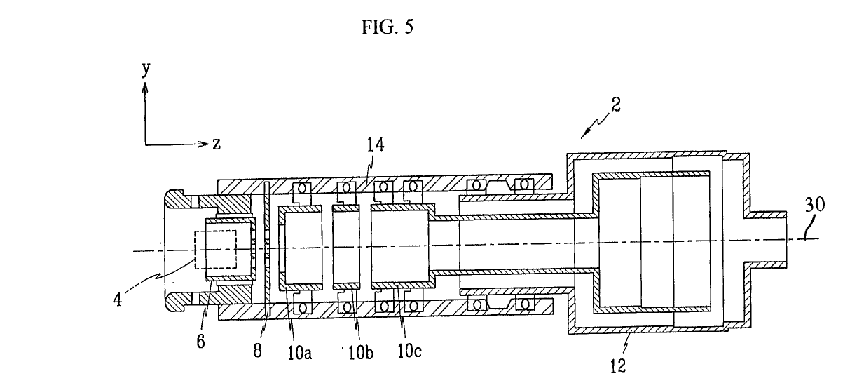

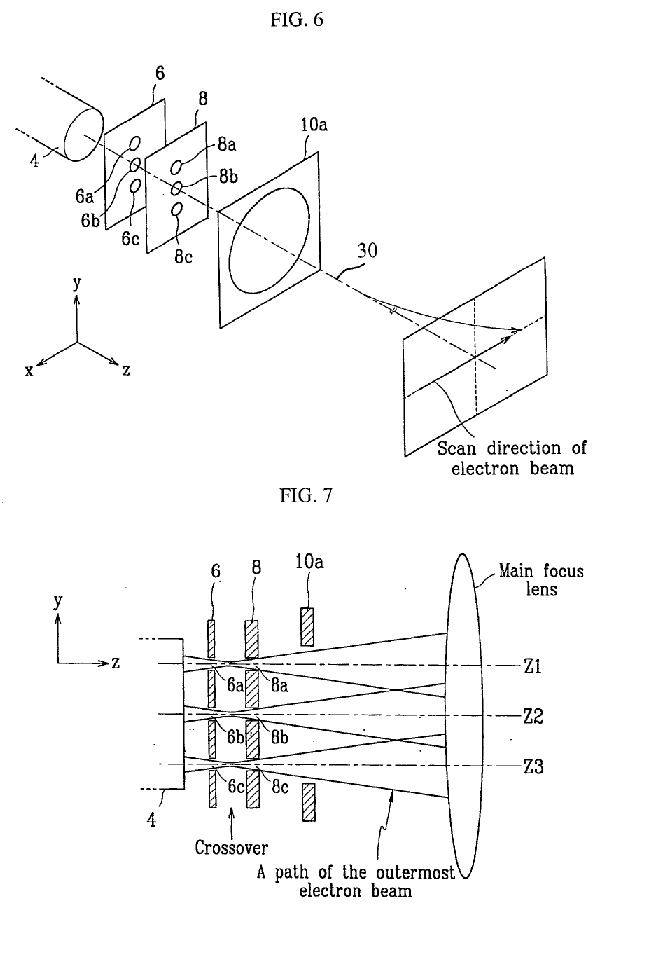

Preferred embodiments of the present invention will now be described in detail with reference to the accompanying drawings. FIG. 5 is a sectional view of an electron gun assembly for a cathode ray tube, in accordance with a first preferred embodiment of the present invention. FIG. 6 is a partial sectional view of the electron gun assembly of FIG. 5, in accordance with the principles of the present invention.

As shown in FIG. 5, an electron gun assembly 2 includes a single cathode 4 that emits electrons; a first electrode 6 and a second electrode 8, which, together with the cathode 4, form a triode portion and control the emission of the electrons; focusing electrodes 10a, 10b, and 10c to which a focus voltage is applied; an anode electrode 12 to which an anode voltage is applied to form a main focus lens (not shown) together with the focusing electrodes 10a, 10b, and 10c; and a pair of supports 14 that extend in a tube-axis direction 30 of the cathode ray tube from the cathode 4 to the anode electrode 12, and align and provide support to the elements therebetween. The tube-axis direction 30 is shown as being parallel to the z-axis direction in the FIGS. 5 and 6.

The focusing electrode 10a closest to the second electrode 8 can be referred to as the first focusing electrode 10a. The focusing electrode 10c furthest from the second electrode 8 can be referred to as the last focusing electrode 10c. Among the focusing electrodes 10a, 10b, and 10c, the focusing electrode 10a is penetrated by the electron beam first, and the focusing electrode 10c is penetrated by the electron beam last.

The electron gun assembly 2 described above is configured including the three separate focusing electrodes 10a, 10b, and 10c, and forms a lens using a uni bi-potential method. However, the number of focusing electrodes is not limited to three, and various focusing methods may be applied according to the number of focusing electrodes and a connecting method used.

There are several types of electrostatic main lenses for color cathode ray tube guns. For example, there are bi-potential lenses, unipotential lenses, and uni bi-potential (hybrid) lenses. The bi-potential lens is a basic form of electron lens used for the main lens of color cathode ray tube guns, and consists of two adjacent coaxial cylindrical electrodes. The unipotential lens consists of three coaxial cylindrical electrodes. A uni bi-potential lens (or hybrid lens) can be formed when a unipotential lens is combined with a bi-potential lens, in accordance with a uni bi-potential method.

A variable voltage is applied to the cathode 4 or the first electrode 6 and a fixed voltage is applied to the second electrode 8. The emission of electrons is controlled by the difference in voltage applied to the cathode 4 and to the first and second electrodes 6 and 8. A pre-focus lens (not shown) is formed between the first and second electrodes 6 and 8, and carries out an initial convergence of the emitted electrons to perform crossover. The focusing electrodes 10a, 10b, and 10c, and the anode electrode 12, to which a high anode voltage (such as, 25 to 30 kilovolts) is applied, form the main focus lens by the difference in voltage applied thereto.

The first electrode 6 includes a plurality of beam passage apertures 6a, 6b, and 6c, and the second electrode 8 includes a plurality of beam passage apertures 8a, 8b, and 8c. The beam passage apertures 6a, 6b and 6c are aligned in a direction perpendicular to a direction at which an electron beam is scanned, as are the beam passage apertures 8a, 8b and 8c.

In a typical horizontal scanning method, the electron beam emitted from an electron gun is scanned in a horizontal-axis direction of a cathode ray tube. With reference to FIG. 6, the electron beam is scanned along the direction substantially parallel to the x-axis. The scanning direction of the electron beam is shown in FIG. 6 to be in a direction substantially perpendicular to the tube-axis direction 30. The electron beam is emitted from the cathode in an emission direction which is substantially parallel to the tube-axis direction 30.

That is, in the typical horizontal scanning method, since the electron beam emitted from the electron gun 2 is scanned in a horizontal-axis direction of the cathode ray tube (parallel to the x-axis in FIG. 6) by a deflection magnetic field generated by a deflection yoke (not shown), the beam passage apertures 6a, 6b and 6c formed in the first electrode 6 and the beam passage apertures 8a, 8b and 8c formed in the second electrode 8 are provided uniformly aligned along the vertical-axis direction of the cathode ray tube. The vertical-axis direction is shown as they-axis direction in FIGS. 5 and 6. This y-axis direction can also be referred to as the alignment direction, with reference to FIGS. 5 and 6.

Shown as an example of how the beam passage apertures 6a, 6b, 6c, 8a, 8b, and 8c may be formed, there are three beam passage apertures formed in each the first electrode 6 and the second electrode 8, and the beam passage apertures 6a, 6b, 6c, 8a, 8b, and 8c are circular in shape.

FIG. 7 is a partially enlarged sectional view of the electron gun assembly of FIG. 5, which is used to describe a path of an electron beam, in accordance with the principles of the present invention. FIG. 7 is a partially enlarged sectional view of the electron gun assembly 2 of FIG. 5. As shown in FIG. 7, a shape and size (that is, an opening size but not necessarily a depth) of all the beam passage apertures 6a, 6b, 6c, 8a, 8b, and 8c are identical, and their center axes are aligned.

That is, a center axis of the beam passage aperture 6a is aligned with a center axis of the beam passage aperture 8a (that is, along axis Z1), a center axis of the beam passage aperture 6b is is aligned with a center axis of the beam passage aperture 8b (that is, along axis Z2), and a center axis of the beam passage aperture 6c is aligned with a center axis of the beam passage aperture 8c (that is, along axis Z3). Axis Z2 is aligned with the tube-axis of the cathode ray tube, and axis Z1 and axis Z3 are equally spaced from the axis Z2 in the vertical-axis direction of the cathode ray tube.

With this structure, electrons emitted from the cathode 4 pass through the beam passage apertures 6a, 6b, and 6c of the first electrode 6, then proceed along the axes Z1, Z2, and Z3, respectively, to pass through the corresponding beam passage apertures 8a, 8b, and 8c. Accordingly, three separate beams are created, each of which undergoes crossover by the pre-focus lens formed between the first and second electrodes 6 and 8. After passing through the beam passage apertures 8a, 8b, and 8c of the second electrode 8, the electron beams travel through the main focus lens, formed within the focusing electrodes 10a, 10b, and 10c, where they undergo simultaneous divergence.

By the formation of separate electron beams as electrons pass through the axes Z1, Z2, and Z3, the electron beams undergo motion according to a trace adjacent to the corresponding axis Z1, Z2, or Z3 such that the size of crossover is reduced.

As a result, a divergence angle of the electron beams directed toward the main focus lens is reduced such that outermost regions of the electron beams are positioned more inwardly than when compared to the electron beam formed with the electron gun described with reference to FIG. 3 above. This results in a minimal influence of spherical aberration so that precise focusing of the electron beam to a specific point on the phosphor screen is possible.

Since the electrons emitted from the cathode 4 directed in the horizontal-axis direction are blocked by the aligned formation of the beam passage apertures 6a, 6b, and 6c in the vertical-axis direction, the resulting electron beam, after passing through the first and second electrodes 6 and 8, is elliptical with a vertical major axis.

As shown in FIG. 7, each one of the beam passage apertures in the first electrode 6 is paired with a respective one of the beam passage apertures in the second electrode 8. In other words, each one of the beam passage apertures in first electrode 6 has a corresponding beam passage aperture in second electrode 8.

The aperture 6a is paired with aperture 8a, and it can be said that the aperture 6a corresponds to aperture 8a. The aperture 6b is paired with aperture 8b, and it can be said that the aperture 6b corresponds to aperture 8b. The aperture 6c is paired with aperture 8c, and it can be said that the aperture 6c corresponds to aperture 8c.

As shown in FIG. 7, the electron beam emitted by the cathode 4 passes through the beam passage apertures in the first electrode 6 and then passes through the beam passage apertures in the second electrode 8. The portion of the electron beam that passes through the aperture 6a then passes through the corresponding aperture 8a. The portion of the electron beam that passes through the aperture 6b then passes through the corresponding aperture 8b. The portion of the electron beam that passes through the aperture 6c then passes through the corresponding aperture 8c.

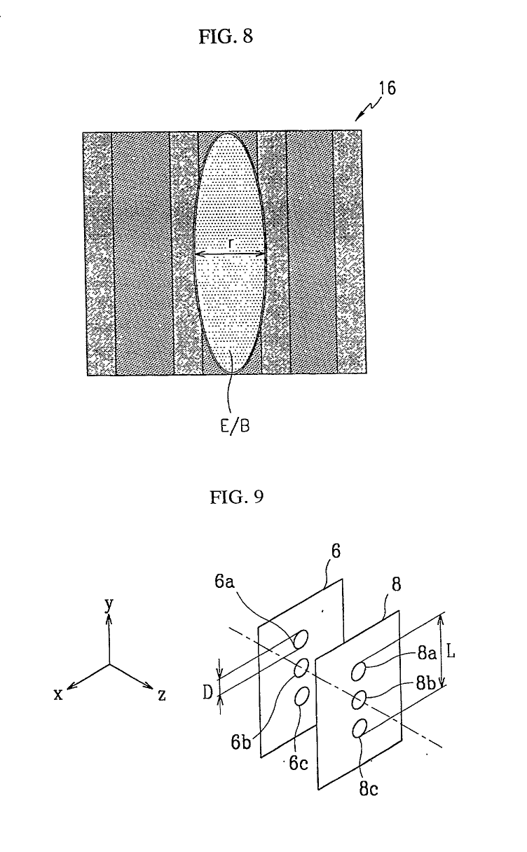

FIG. 8 is a partial enlarged view of a phosphor screen used to describe a spot formation of an electron beam emitted from the electron gun assembly of FIG. 5, in accordance with the principles of the present invention. FIG. 9 is a schematic view of a first electrode and a second electrode of the electron gun assembly of FIG. 5, in accordance with the principles of the present invention.

With reference to FIGS. 5-8, the electron gun assembly 2 is able to realize an elliptical spot formation such that a diameter (r) of the electron beam in the horizontal-axis direction is reduced. Hence, with reference to FIG. 8, an elliptical spot of an electron beam (E/B) that does not illuminate undesired colors is realized, in accordance with the principles of the present invention.

With reference to FIGS. 5-8, by adjusting parameters of the beam passage apertures 6a, 6b, 6c, 8a, 8b, and 8c, a horizontal diameter (r) of the electron beam landing on a phosphor screen 16 may be easily controlled. With reference to FIG. 9, the parameters include a diameter D of the beam passage apertures 6a, 6b, 6c, 8a, 8b, and 8c, and also a length L. Because the beam apertures 6a, 6b, 6c, 8a, 8b, and 8c are the same size and shape, with reference to FIG. 9, the diameter D is equal for all of them. The length L extends from extreme points of the outermost beam passage apertures 6a and 6c in the vertical-axis direction (y-axis direction). The length L also extends from extreme points of the outermost beam passage apertures 8a and 8c in the vertical-axis direction (y-axis direction).

Preferably, the diameter D and the length L satisfy the following two equations, considering a stable gap between the beam passage apertures and an aspect ratio of the whole beam passage apertures.

0.1 mm≦D≦0.3 mm [Equation 1]

2D≦L≦8D [Equation 2]

Equation 1 indicates that the diameter D must be less than or equal to 0.3 millimeters, and must be greater than or equal to 0.1 millimeters. Equation 2 indicates that the length L must be less than or equal to the diameter D multiplied by 8, and must be greater than or equal to the diameter D multiplied by 2.

With reference to FIG. 9, when a person is positioned below the second electrode 8 and views along the alignment direction (y-axis direction) from that position, the beam passage apertures in the second electrode 8 can be said to include a highest aperture 8a and a lowest aperture 8c. A length L is the distance from the top edge of the highest aperture 8a to the bottom edge of the lowest aperture 8c, when viewed along the alignment direction. The terms highest and lowest can vary depending upon the orientation of the second electrode 8, of course. However, when a person views the apertures 8a-8c of the second electrode 8 along the alignment direction as described above, the aperture 8a will appear to be furthest away from the viewer (the highest aperture) and the aperture 8c will appear to be closest to the viewer (the lowest aperture).

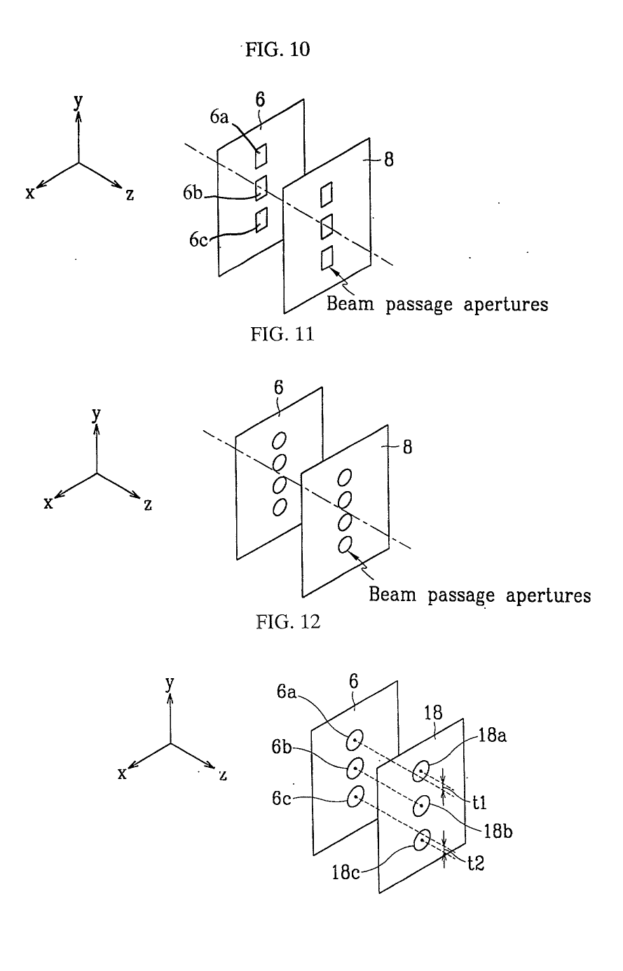

FIG. 10 is a schematic view showing a first alternate configuration for the first and second electrodes of FIG. 9, in accordance with the principles of the present invention. FIG. 11 is a schematic view showing a second alternate configuration for the first and second electrodes of FIG. 9, in accordance with the principles of the present invention.

The beam passage apertures of the first and second electrodes 6 and 8 may be rectangular in shape with long sides of the rectangles in the vertical-axis direction as shown in FIG. 10, or may be circular as shown in FIG. 9. The first and second electrodes 6 and 8 may each have four circular beam passage apertures as shown in FIG. 11.

Furthermore, the at least one beam passage aperture formed in the second electrode 8 may be off-center in the tube-axis direction from a corresponding beam passage aperture in the first electrode 6 along the vertical-axis direction of the cathode ray tube. An off-center configuration will be described with reference to FIGS. 12-14, in accordance with the principles of the present invention.

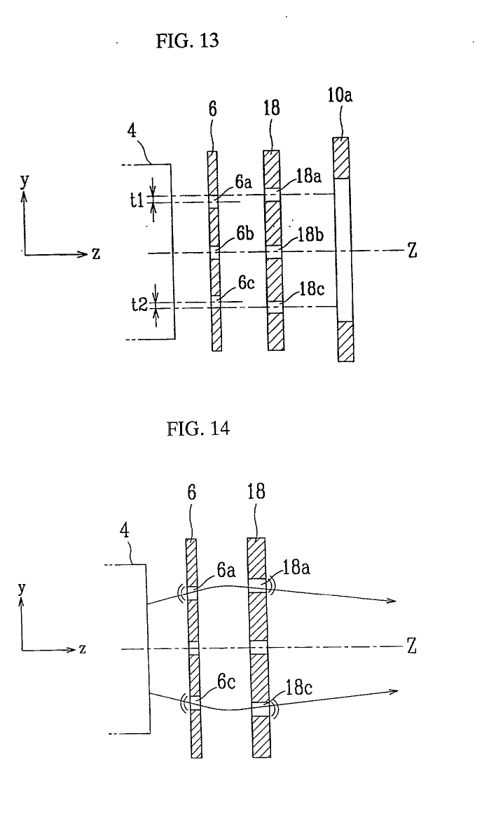

FIG. 12 is a schematic view showing a third alternate configuration for the first and second electrodes of FIG. 9, in accordance with the principles of the present invention. FIG. 13 is a sectional view of the first and second electrodes of FIG. 12, in accordance with the principles of the present invention. FIG. 14 is a sectional view of the first and second electrodes of FIG. 12 used to describe a path of an electron beam, in accordance with the principles of the present invention.

FIG. 12 is a schematic view of the first electrode 6 and a second electrode 18. FIG. 13 is a sectional view of the first electrode 6 and the second electrode 18 shown in FIG. 12. FIG. 14 is a sectional view of the first electrode 6 and the second electrode 18 shown in FIG. 12 used to describe a path of an electron beam.

With reference to FIGS. 12-14, a beam passage aperture 18b of the second electrode 8 is centered with the beam passage aperture 6b of the first electrode 6 such that the tube-axis of the cathode ray tube passes through their centers.

With reference to FIGS. 12-14, an imaginary axis passing through a center of a beam passage aperture 18a in the tube-axis direction is at a distance t1 away from an imaginary axis passing through the center of the beams passage aperture 6a along the vertical-axis direction of the cathode ray tube. Likewise, an imaginary axis passing through a center of a beam passage aperture 18c in the tube-axis direction is at a distance t2 away from an imaginary axis passing through a center of the beams passage aperture 6c along the vertical-axis direction of the cathode ray tube.

As shown in FIGS. 12-14, each one of the apertures 6a, 6b, and 6c is paired with one of the apertures 18a, 18b, and 18c. The aperture 6a is paired with, or corresponds to, aperture 18a. The aperture 6a corresponds to the aperture 18a because the location of aperture 6a at least approximately corresponds to the location of aperture 18a. Portions of the electron beam that pass through aperture 6a will also pass through the corresponding aperture 18a. Apertures 6a and 18a are not exactly aligned with each other, but they still correspond to each other.

As shown in FIGS. 12-14, the centers of apertures 6b and 18b are aligned with each other. The apertures 6b and 18b can be said to be paired with each other, and can be said to correspond to each other. The centers of apertures 6c and 18c are not aligned with each other. Nevertheless, the apertures 6c and 18c can be said to be paired with each other, and can be said to correspond to each other.

With reference to FIG. 14, because of the off-center configuration of the beam passage aperture 18a with the beam passage aperture 6a, and between the beam passage apertures 6c and 18c, the electrons passing through these beam passage apertures 6a, 18a, 6c, and 18c receive a bent-lens effect.

Accordingly, the path of the resulting electron beams is converged in the vertical-axis direction. The degree to which the electron beam is bent depends on the voltage applied to the first and second electrodes 6 and 18, and to the distances t1 and t2. Accordingly, convergence in the vertical-axis direction (y-axis direction) may be easily controlled by varying these conditions.

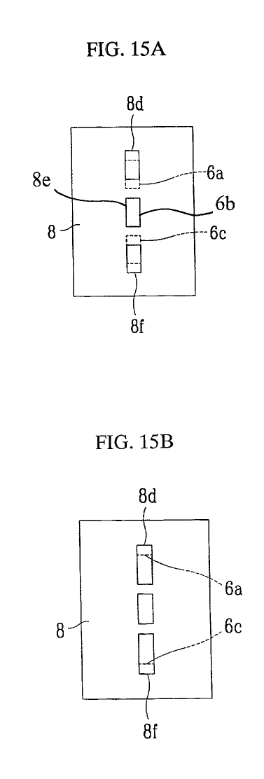

FIG. 15A is a schematic view showing a fourth alternate configuration for the first and second electrodes of FIG. 10, in accordance with the principles of the present invention. FIG. 15A shows an off-center configuration of the first and second electrodes 6 and 8 of FIG. 10, as viewed along the z-axis direction. The beam passage apertures of the first electrode 6 of FIG. 10 are shown by the dotted lines. The outermost beam passage apertures 8d and 8f of the second electrode 8 are off-centered along the vertical-axis direction of the cathode ray tube with outermost beam passage apertures 6a and 6c of the first electrode 6. The aperture 6b of FIG. 10 is exactly aligned with the aperture 8e of FIG. 15A, as shown in FIG. 15A. The edges of rectangular aperture 8e are aligned with the edges of rectangular aperture 6b, and the center of rectangular aperture 8e is aligned with the center of rectangular aperture 6b, as shown in FIG. 15A.

FIG. 15B is a schematic view showing a fifth alternate configuration for the first and second electrodes of FIG. 10, in accordance with the principles of the present invention. FIG. 15B shows an off-center configuration of the first and second electrodes 6 and 8 of FIG. 10, as viewed along the z-axis direction. The beam passage apertures of the first electrode 6 of FIG. 10 are shown by the dotted lines. The outermost beam passage apertures 8d and 8f of the second electrode 8 are larger than the outermost beam passage apertures 6a and 6c of the first electrode 6. Furthermore, the outermost beam passage apertures 8d and 8f of the second electrode 8 are off-centered along the vertical-axis direction of the cathode ray tube with the outermost beam passage apertures 6a and 6c of the first electrode 6.

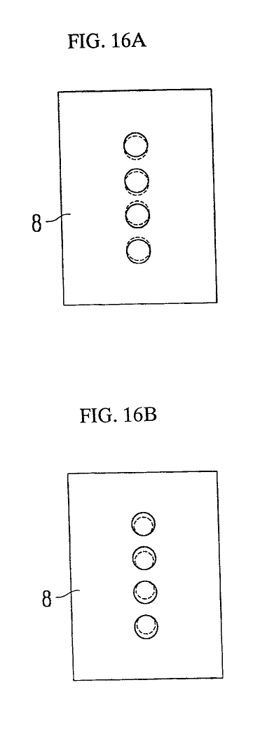

FIG. 16A is a schematic view showing a sixth alternate configuration for the first and second electrodes of FIG. 11, in accordance with the principles of the present invention. FIG. 16A shows an off-center configuration of the first electrode 6 and the second electrode 8 of FIG. 11, as viewed along the z-axis direction. The beam passage apertures of the first electrode 6 of FIG. 11 are shown by the dotted lines. In FIG. 16A, the beam passage apertures of the second electrode 8 are all off-centered along the vertical-axis direction of the cathode ray tube with the beam passage apertures of the first electrode 6.

FIG. 16B is a schematic view showing a seventh alternate configuration for the first and second electrodes of FIG. 11, in accordance with the principles of the present invention. FIG. 16B shows an off-center configuration of the first electrode 6 and the second electrode 8 of FIG. 11, as viewed along the z-axis direction. The beam passage apertures of the first electrode 6 of FIG. 11 are shown by the dotted lines. In FIG. 16B, the beam passage apertures of the second electrode 8 are all off-centered along the vertical-axis direction of the cathode ray tube with the beam passage apertures of the first electrode 6. Furthermore, in FIG. 16B, the beam passage apertures of the second electrode 8 are larger than the beam passage apertures of the first electrode 6.

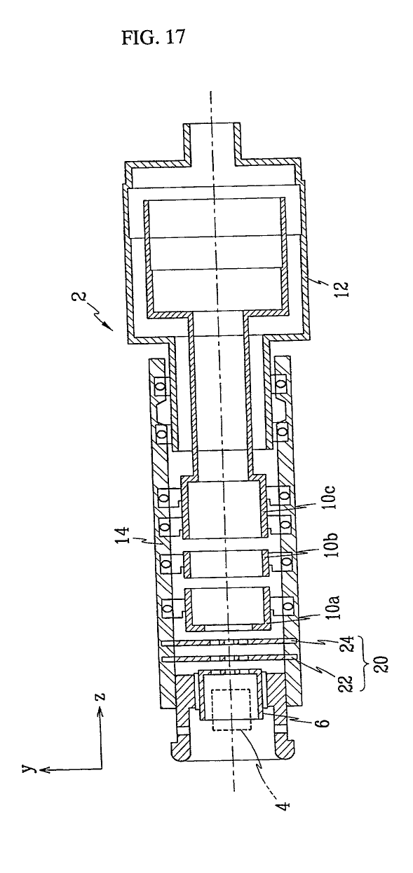

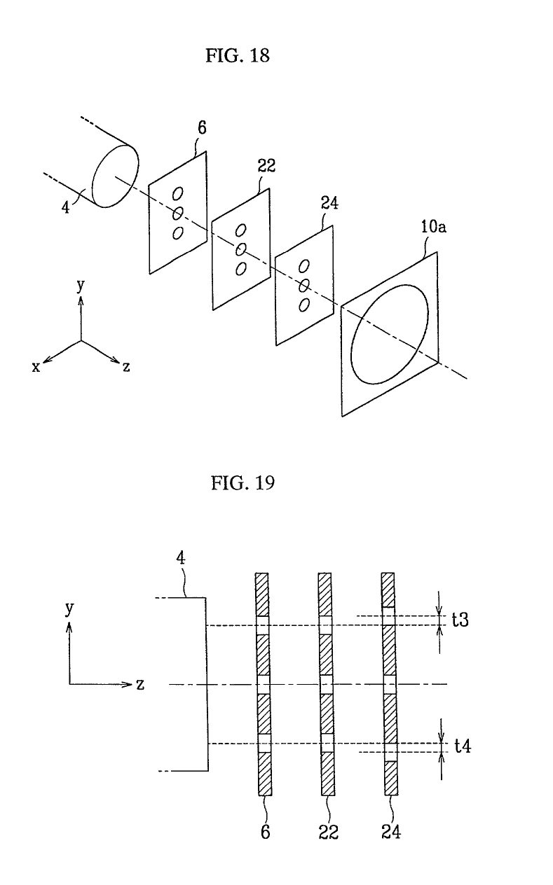

FIG. 17 is a sectional view of an electron gun assembly for a cathode ray tube, in accordance with a second preferred embodiment of the present invention. FIG. 18 is a partial sectional view of the electron gun assembly of FIG. 17, in accordance with the principles of the present invention. The same reference numerals for elements identical to the first preferred embodiment of the present invention will be used.

A second electrode 20 includes a first sub-electrode 22 provided opposing a first electrode 6, and a second sub-electrode 24 provided opposing a focusing electrode 10a. That is, among focusing electrodes 10a, 10b, and 10c, the second sub-electrode 24 is mounted opposing the focusing electrode 10a, which is closest to a cathode 4 among the focusing electrodes 10a, 10b, and 10c.

The first electrode 6, the first sub-electrode 22, and the second sub-electrode 24 include a plurality of beam passage apertures, which are aligned on each of these elements in a direction perpendicular to the direction at which the electron beam is scanned. That is, the beam passage apertures formed in the first electrode 6, the first sub-electrode 22 and the second sub-electrode 24, are aligned in the vertical-axis direction of the cathode ray tube.

As an example, three circular beam passage apertures are formed in each the first electrode 6, the first sub-electrode 22, and the second sub-electrode 24, and the shape and size of the beam passage apertures are identical. Further, the beam passage apertures are provided such that centers of the beam passage apertures in the first electrode 6 are aligned in a tube-axis direction (shown as z-axis direction in FIG. 17) of the cathode ray tube with centers of the corresponding beam passage apertures in the first and second sub-electrodes 22 and 24.

A fixed voltage is applied to the first sub-electrode 22 and a different fixed voltage is applied to the second sub-electrode 24. It is also possible to apply a dynamic focus voltage to the second sub-electrode 24 while applying a fixed voltage to the first sub-electrode 22. The dynamic focus voltage can be synchronized with a deflection frequency of a deflection yoke, for example.

With the structure of the second electrode 20 including the first and second sub-electrodes 22 and 24 as described above, the first electrode 6 and the second electrode 20 operate under the same principles as described with reference to the first preferred embodiment (as shown in FIG. 5) to reduce a horizontal diameter of a resulting electron beam. That is, the resulting electron beam has an elliptical spot with a vertical-axis when landing on a phosphor screen, similar to the elliptical spot shown in FIG. 8.

Preferably, the beam passage apertures of the first electrode 6, and the first and second sub-electrodes 22 and 24 satisfy the conditions of Equations 1 and 2 described with reference to the first preferred embodiment of the present invention.

FIG. 19 is a sectional view of the first electrode, the first sub-electrode, and the second sub-electrode of FIG. 17 used to describe an alternate configuration for the second sub-electrode, in accordance with the principles of the present invention. With reference to FIG. 19, at least one of the beam passage apertures formed in the second sub-electrode 24 may be off-centered with corresponding beam passage apertures formed in the first electrode 6 and the first sub-electrode 22 along the vertical-axis direction of the cathode ray tube.

That is, an imaginary axis passing through a center of the at least one beam passage aperture of the second sub-electrode 24 in the tube-axis direction may be distanced in the vertical-axis direction from an imaginary axis passing through centers of the corresponding beam passage apertures of the first electrode 6 and the first sub-electrode 22.

Such off-centering may also be accompanied by a larger size of the beam passage aperture(s) of the second sub-electrode 24 than the beam passage apertures of the first electrode 6 and the first sub-electrode 22.

The beam passage apertures 6a, 6b, 6c, 8a, 8b, 8c, 8d, 8e, 8f, 18a, 18b, and 18c are shown in a circular shape and a rectangular shape. It is within the scope of the present invention to utilize shapes for the apertures other than circular and rectangular shapes. The apertures could be formed to have an elliptical shape, a diamond shape, square shape, pentagon shape, and/or other shapes.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit or scope of the applicant's general inventive concept.

What is claimed is:

1. An electron gun apparatus for a cathode ray tube, comprising:
a single cathode emitting an electron beam, the electron beam being scanned in a scanning direction;
a first electrode being mounted adjacent to said cathode, said first electrode forming a first plurality of beam passage apertures aligned in an alignment direction substantially perpendicular to the scanning direction;
a second electrode being mounted adjacent to said first electrode, said first electrode being disposed between said second electrode and said cathode, said cathode and first and second electrodes forming a triode portion, said second electrode forming a second plurality of beam passage apertures aligned in the alignment direction, the electron beam penetrating at least one of the first plurality of beam passage apertures and at least one of the second plurality of beam passage apertures;
a plurality of focusing electrodes being mounted adjacent to each other, said focusing electrodes including one focusing electrode mounted adjacent to said second electrode and including a last focusing electrode, the one focusing electrode being disposed between said second electrode and the last focusing electrode;
an anode electrode being mounted adjacent to the last focusing electrode; and
at least one support providing support to said cathode and said electrodes.

2. The apparatus of claim 1, each of the first and second plurality of beam passage apertures having a diameter D being less than or equal to 0.3 millimeters and being greater than or equal to 0.1 millimeters, the first plurality of beam passage apertures having a highest aperture above all other ones of the first plurality of beam passage apertures and having a lowest aperture below all other ones of the first plurality of beam passage apertures when viewed along the alignment direction, the highest aperture having a top edge and the lowest aperture having a bottom edge when viewed along the alignment direction, the length L from the top edge of the highest aperture to the bottom edge of the lowest aperture being less than or equal to 8D and being greater than or equal to 2D.

3. The apparatus of claim 1, said cathode emitting the electron beam in a tube-axis direction substantially perpendicular to the scanning direction, the alignment direction being substantially perpendicular to the scanning and tube-axis directions.

4. The apparatus of claim 3, each one of the first plurality of beam passage apertures having a center aligned with a center of a respective one of the second plurality of beam passage apertures as viewed in a direction substantially parallel to the tube-axis direction.

5. The apparatus of claim 3, every one of the first plurality of beam passage apertures and every one of the second plurality of beam passage apertures having a same size and a same shape.

6. The apparatus of claim 5, each one of the first plurality of beam passage apertures having a center aligned with a center of a respective one of the second plurality of beam passage apertures as viewed in a direction substantially parallel to the tube-axis direction.

7. The apparatus of claim 6, each of the first and second plurality of beam passage apertures having a diameter D being less than or equal to 0.3 millimeters and being greater than or equal to 0.1 millimeters, the first plurality of beam passage apertures having a highest aperture above all other ones of the first plurality of beam passage apertures and having a lowest aperture below all so other ones of the first plurality of beam passage apertures when viewed along the alignment direction, the highest aperture having a top edge and the lowest aperture having a bottom edge when viewed along the alignment direction, the length L from the top edge of the highest aperture to the bottom edge of the lowest aperture being less than or equal to 8D and being greater than or equal to 2D.

8. The apparatus of claim 3, each one of the first plurality of beam passage apertures being formed to have a position corresponding to a respective one of the second plurality of beam passage apertures, the first plurality of beam passage apertures including at least a first beam passage aperture, the second plurality of beam passage apertures including at least a second beam passage aperture having a position at least approximately corresponding to a position of the first beam passage aperture, the first beam passage aperture being adjacent to the second beam passage aperture, portions of the electron beam passing through both the first beam passage aperture and the second beam passage aperture, the first beam passage aperture having a center not aligned with a center of the second beam passage aperture as viewed in a direction substantially parallel to the tube-axis direction.

9. The apparatus of claim 8, the center of the first beam passage aperture being spaced apart from the center of the second beam passage aperture in the alignment direction.

10. The apparatus of claim 9, the second beam passage aperture being larger than the first beam passage aperture.

11. The apparatus of claim 3, said second electrode including a first sub-electrode mounted adjacent to said first electrode and including a second sub-electrode mounted between said first sub-electrode and said plurality of focusing electrodes, said first sub-electrode forming a third plurality of beam passage apertures, said second sub-electrode forming a fourth plurality of beam passage apertures, each one of the third plurality of beam passage apertures having a center aligned with a center of a respective one of the fourth plurality of beam passage apertures in a direction substantially parallel to the tube-axis direction.

12. The apparatus of claim 11, every one of the first plurality of beam passage apertures and every one of the third plurality of beam passage apertures and every one of the fourth plurality of beam passage apertures having a same size and a same shape.

13. The apparatus of claim 12, each one of the first plurality of beam passage apertures having a center aligned with a center of a respective one of the third plurality of beam passage apertures and with a center of a respective one of the fourth plurality of beam passage apertures in a direction substantially parallel to the tube-axis direction.

14. The apparatus of claim 11, each of the first, third, and fourth plurality of beam passage apertures having a diameter D being less than or equal to 0.3 millimeters and being greater than or equal to 0.1 millimeters, the third plurality of beam passage apertures having a highest aperture above all other ones of the first plurality of beam passage apertures and having a lowest aperture below all other ones of the first plurality of beam passage apertures when viewed along the alignment direction, the highest aperture having a top edge and the lowest aperture having a bottom edge when viewed along the alignment direction, the length L from the top edge of the highest aperture to the bottom edge of the lowest aperture being less than or equal to 8D and being greater than or equal to 2D.

15. The apparatus of claim 11, each one of the third plurality of beam passage apertures being formed to have a position corresponding to a respective one of the fourth plurality of beam passage apertures, the third plurality of beam passage apertures including at least a first beam passage aperture, the fourth plurality of beam passage apertures including at least a second beam passage aperture having a position at least approximately corresponding to a position of the first beam passage aperture, the first beam passage aperture being adjacent to the second beam passage aperture, portions of the electron beam passing through both the first beam passage aperture and the second beam passage aperture, the first beam passage aperture having a center not aligned with a center of the second beam passage aperture as viewed in a direction substantially parallel to the tube-axis direction.

16. The apparatus of claim 15, the center of the first beam passage aperture being spaced apart from the center of the second beam passage aperture in the alignment direction.

17. The apparatus of claim 16, the second beam passage aperture being larger than the first beam passage aperture.

18. An apparatus for a cathode ray tube, comprising:
a cathode emitting an electron beam toward a screen, the electron beam being scanned in a scanning direction;
a first electrode being mounted adjacent to said cathode, said first electrode forming at least three beam passage apertures aligned in an alignment direction perpendicular to the scanning direction;
a second electrode being mounted adjacent to said first electrode, said first electrode being disposed between said second electrode and said cathode, said second electrode forming at least three beam passage apertures aligned in the alignment direction, each one of the beam passage apertures of said first electrode being formed to have a position corresponding to a respective one of the beam passage apertures of said second electrode;
three focusing electrodes being mounted adjacent to each other, said focusing electrodes including a first focusing electrode mounted adjacent to said second electrode and including a last focusing electrode, the first focusing electrode being disposed between said second electrode and the last focusing electrode;
an anode electrode being mounted adjacent to the last focusing electrode, the electron beam being emitted through at least one of the beam passage apertures of said first electrode, at least one of the beam passage apertures of said second electrode, said focusing electrodes, and said anode electrode and to the screen; and
at least one support providing support to said cathode and said electrodes.

19. An apparatus for a cathode ray tube, comprising:
a single cathode emitting an electron beam, the electron beam being scanned in a scanning direction;
a first electrode being mounted adjacent to said cathode, said first electrode forming a plurality of beam passage apertures aligned in an alignment direction substantially perpendicular to the scanning direction;
a second electrode being mounted adjacent to said first electrode, said first electrode being disposed between said second electrode and said cathode, said cathode and first and second electrodes forming a triode portion, said second electrode forming a second plurality of beam passage apertures aligned in the alignment direction, each one of the first plurality of beam passage apertures being formed to have a position corresponding to a respective one of the second plurality of beam passage apertures;
a plurality of focusing electrodes being mounted adjacent to each other, said focusing electrodes including a first focusing electrode mounted adjacent to said second electrode and including a last focusing electrode, the first focusing electrode being disposed between said second electrode and the last focusing electrode;
an anode electrode being mounted adjacent to the last focusing electrode, the electron beam penetrating at least one of the first plurality of beam passage apertures, at least one of the second plurality of beam passage apertures, said focusing electrodes, and said anode electrode; and
a support supporting said cathode and said electrodes;
said cathode emitting the electron beam in a tube-axis direction substantially perpendicular to the scanning direction, the alignment direction being substantially perpendicular to the scanning and tube-axis directions;
at least one of the first plurality of beam passage apertures having a center aligned with a center of a corresponding one of the second plurality of beam passage apertures as viewed in a direction substantially parallel to the tube-axis direction;
at least one of the first plurality of beam passage apertures having a center not aligned with a center of a corresponding one of the second plurality of beam passage apertures as viewed in a direction substantially parallel to the tube-axis direction.

20. The apparatus of claim 19, the first and second plurality of apertures having a shape selected from among circular and rectangular as viewed in a direction substantially parallel to the tube-axis direction, at least one of the second plurality of beam passage apertures being larger than at least one of the first plurality of beam passage apertures.
